(19) United States
(12) Patent Application Publication
(10) Pub. No.: US 2018/0365986 A1
(43) Pub. Date: Dec. 20, 2018

(54) DRIVER FATIGUE WARNING SYSTEM

(71) Applicant: Delphi Technologies, Inc., Troy, MI (US)

(72) Inventor: Premchand Krishna Prasad, Carmel, IN (US)

(21) Appl. No.: 15/622,277

(22) Filed: Jun. 14, 2017

(51) Int. Cl. G08G 1/01; G06K 9/00; H04N 7/18; G08G 1/054

(52) U.S. Cl. CPC G08G 1/0141; G06K 9/00818; G08G 1/054; G08G 1/0112; H04N 7/183

(57) ABSTRACT

A driver-fatigue warning system includes a speed-limit-detection-means, a speed-sensor, an alert-device, and a controller. The speed-limit-detection-means detects a speed-limit of a roadway traveled by a host-vehicle. The speed-sensor detects a speed of the host-vehicle. The alert-device is operable to alert an operator of the host-vehicle of driver-fatigue. The controller is in communication with the speed-limit-detection-means, the speed-sensor, and the alert-device. The controller determines a change of the speed-limit of the roadway based on the speed-limit-detection-means. The controller determines that a speed-change has occurred based on the speed-sensor when a variation in the speed is greater than a variation-threshold. The controller does not increment a count of occurrences of the speed-change when the speed-change correlates with the change of the speed-limit, and activates the alert-device when the count of occurrences of the speed-change exceeds a change-threshold indicative of driver-fatigue.

### TECHNICAL FIELD OF INVENTION

This disclosure generally relates to a driver-fatigue warning system, and more particularly relates to a driver-fatigue warning system that does not penalize a driver for responding to a speed-limit change.

### BACKGROUND OF INVENTION

It is known to detect a driver's level of fatigue by tracking a speed-change of a vehicle. Excessive occurrences of speed-change may indicate an unsafe level of driver-fatigue and may lead to an activation of an alert-device that alerts the driver to their lowered level of responsiveness.

### SUMMARY OF THE INVENTION

In accordance with one embodiment, a driver-fatigue warning system is provided. The driver-fatigue warning system includes a speed-limit-detection-means, a speed-sensor, an alert-device, and a controller. The speed-limit-detection-means detects a speed-limit of a roadway traveled by a host-vehicle. The speed-sensor detects a speed of the host-vehicle. The alert-device is operable to alert an operator of the host-vehicle of driver-fatigue. The controller is in communication with the speed-limit-detection-means, the speed-sensor, and the alert-device. The controller determines a change of the speed-limit of the roadway based on the speed-limit-detection-means. The controller determines that a speed-change has occurred based on the speed-sensor when a variation in the speed is greater than a variation-threshold. The controller does not increment a count of occurrences of the speed-change when the speed-change correlates with the change of the speed-limit, and activates the alert-device when the count of occurrences of the speed-change exceeds a change-threshold indicative of driver-fatigue.

In another embodiment, a method of operating a driver-fatigue warning system is provided. The method includes the steps of detecting a speed-limit, detecting a speed of a host-vehicle, determining a change in the speed-limit, determining a speed-change, and activating an alert-device. The step of detecting the speed-limit may include detecting, with a speed-limit-detection-means, the speed-limit of a roadway traveled by a host-vehicle. The step of detecting the speed of the host-vehicle may include detecting, with a speed-sensor, the speed of the host-vehicle. The step of determining the change in the speed-limit may include determining, with a controller in communication with the speed-limit-detection-means, the speed-sensor, and the alert-device, a change of the speed-limit of the roadway based on the speed-limit-detection-means. The step of determining the speed-change may include determining, with the controller, that the speed-change has occurred based on the speed-sensor when a variation in the speed is greater than a variation-threshold, and not counting occurrences of the speed-change when the speed-change correlates with the change of the speed-limit. The step of activating the alert-device may include activating, with the controller, the alert-device that alerts an operator of the host-vehicle when a count of occurrences of the speed-change exceeds a change-threshold indicative of driver-fatigue.

In yet another embodiment, an automated vehicular warning system is provided. The automated vehicular warning system includes a speed-limit detector, a speed-sensor, an alert-device, and a controller in communication with the speed-limit detector, the speed-sensor, and the alert-device. The controller determines a change of a speed-limit of a roadway. The controller also determines a change of a vehicle-speed, and does not count the change of the vehicle-speed when the vehicle-speed agrees with the change of the speed-limit. The controller activates the alert-device when the count of the change of vehicle-speed exceeds a change-threshold indicative of driver-fatigue.

Further features and advantages will appear more clearly on a reading of the following detailed description of the preferred embodiment, which is given by way of non-limiting example only and with reference to the accompanying drawings.

### BRIEF DESCRIPTION OF DRAWINGS

The present invention will now be described, by way of example with reference to the accompanying drawings, in which:

FIG. 1 is an illustration of a driver-fatigue warning system in accordance with one embodiment;

FIG. 2 is an illustration of a host-vehicle equipped with the driver-fatigue warning system of FIG. 1 in accordance with one embodiment;

FIG. 3 is an illustration of the host-vehicle of FIG. 2 in accordance with one embodiment;

FIG. 4 is an illustration of the host-vehicle of FIG. 2 in accordance with one embodiment;

FIG. 5 is an illustration of a method of operating the driver-fatigue warning system of FIG. 1 in accordance with another embodiment;

FIG. 6 is an illustration of an automated vehicular warning system in accordance with yet another embodiment;

FIG. 7 is an illustration of a host-vehicle equipped with the automated vehicular warning system of FIG. 6 in accordance with yet another embodiment;

FIG. 8 is an illustration of the host-vehicle of FIG. 7 in accordance with yet another embodiment;

FIG. 9 is an illustration of the host-vehicle of FIG. 7 in accordance with yet another embodiment; and

FIG. 10 is a flow chart of a driver-fatigue algorithm in accordance with one embodiment.

### DETAILED DESCRIPTION

A typical driver-fatigue warning system detects whether an operator of a host-vehicle is drowsy or fatigued by tracking a variation in a speed of the host-vehicle. While the typical driver-fatigue warning system may accurately estimate the driver-fatigue under ideal traffic conditions, situations exist where the operator may intentionally change speed due to a change of a posted speed-limit. While these speed changes may be due to the driver observing the traffic laws, they may be erroneously counted by the typical driver-fatigue warning system as an indication of driver-fatigue, and may lead to a false driver-fatigue warning. As will be described in more detail below, the system described herein is an improvement over prior driver-fatigue warning systems because the system reduces the rates of false driver-fatigue warnings by determining when to count the speed change, which may help to reduce occurrences of operators intentionally deactivating the driver-fatigue warning system.

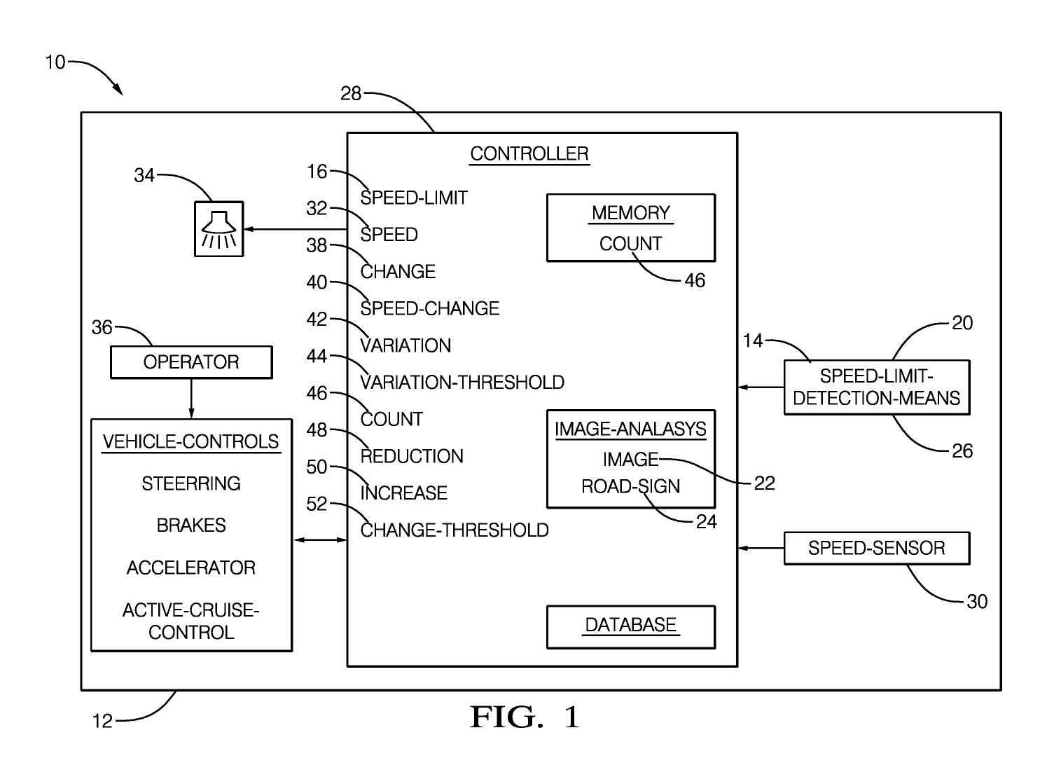

FIG. 1 illustrates a non-limiting example of a driver-fatigue warning system 10, hereafter referred to as the system 10, suitable for use on an automated vehicle 12, hereafter referred to a host-vehicle 12. The system 10 includes a speed-limit-detection-means 14 that detects a speed-limit 16 of a roadway 18 traveled by the host-vehicle 12.

The speed-limit-detection-means 14 may be a camera 20 that renders an image 22 of a road-sign 24 proximate to the roadway 18. Examples of the camera 20 suitable for use on the host-vehicle 12 are commercially available as will be recognized by those in the art, one such being the APTINA MT9V023 from Micron Technology, Inc. of Boise, Id., USA. The camera 20 may be mounted on the front of the host-vehicle 12, or mounted in the interior of the host-vehicle 12 at a location suitable for the camera 20 to view the area around the host-vehicle 12 through the windshield of the host-vehicle 12. The camera 20 is preferably a video-type camera 20 or camera 20 that can capture images 22 of the roadway 18 and surrounding area at a sufficient frame-rate, of ten frames per second, for example.

The speed-limit-detection-means 14 may be a digital-map 26 that indicates the speed-limit 16 of the roadway 18. The digital-map 26 may be located on-board the host-vehicle 12 and may be integrated into a controller 28. The digital-map 26 may be stored ‘in the cloud’ and accessed via a transceiver (e.g. Wi-Fi, cellular, satellite—not shown). The digital-map 26 and transceiver may also be part of a location-device (e.g. GPS—not shown).

The system 10 also includes a speed-sensor 30 that detects a speed 32 of the host-vehicle 12. The speed-sensor 30 may include a wheel-speed-sensor (not shown) typically found on automotive applications. Other sensors capable of determining the speed 32 of the host-vehicle 12 may include, but are not limited to, a global-positioning-system (GPS) receiver (not shown), and a RADAR transceiver (not shown), and other devices as will be recognized by those skilled in the art.

The system 10 also includes an alert-device 34 operable to alert an operator 36 of the host-vehicle 12 of driver-fatigue. The alert-device 34 may be an indicator viewable by the operator 36 that is illuminated to indicate an instance of driver-fatigue, and/or an audible alarm, and/or a vibratory alarm that is activated to indicate the same.

The system 10 also includes the controller 28 in communication with the speed-limit-detection-means 14, the speed-sensor 30, and the alert-device 34. The controller 28 may include a processor (not shown) such as a microprocessor or other control circuitry such as analog and/or digital control circuitry including an application specific integrated circuit (ASIC) for processing data as should be evident to those in the art. The controller 28 may include a memory (not specifically shown), including non-volatile memory, such as electrically erasable programmable read-only memory (EEPROM) for storing one or more routines, thresholds, and captured data. The one or more routines may be executed by the processor to perform steps for determining if a detected instance of driver-fatigue exists based on signals received by the controller 28 from the speed-limit-detection-means 14 and the speed-sensor 30, as described herein.

The controller 28 may be configured to receive the image 22 from the camera 20 and detect characters (not specifically shown) on the road-sign 24 in order to determine the speed-limit 16. The controller 28 may use known optical-character-recognition (OCR) methods to match the characters in the image 22 captured by the camera 20 with the characters in a database (not specifically shown). One skilled in the art of OCR will recognize that methods such as optical-word-recognition (OWR), intelligent-character-recognition (ICR), and intelligent-word-recognition (IWR) are all considered OCR methods and may be applied by the controller 28 to determine the speed-limit 16. The OCR methods may include pre-processing of the image 22 to improve the success rate of recognition of the characters, matrix-matching, feature extraction, and application-specific optimizations, and will be recognized by those skilled in the art of OCR.

The controller 28 may also include an internet-transceiver (not shown) that updates the digital-map 26 with speed-limit 16 information. The internet-transceiver may be any internet-transceiver suitable for automotive applications and may include Wi-Fi, cellular, and satellite devices (not shown).

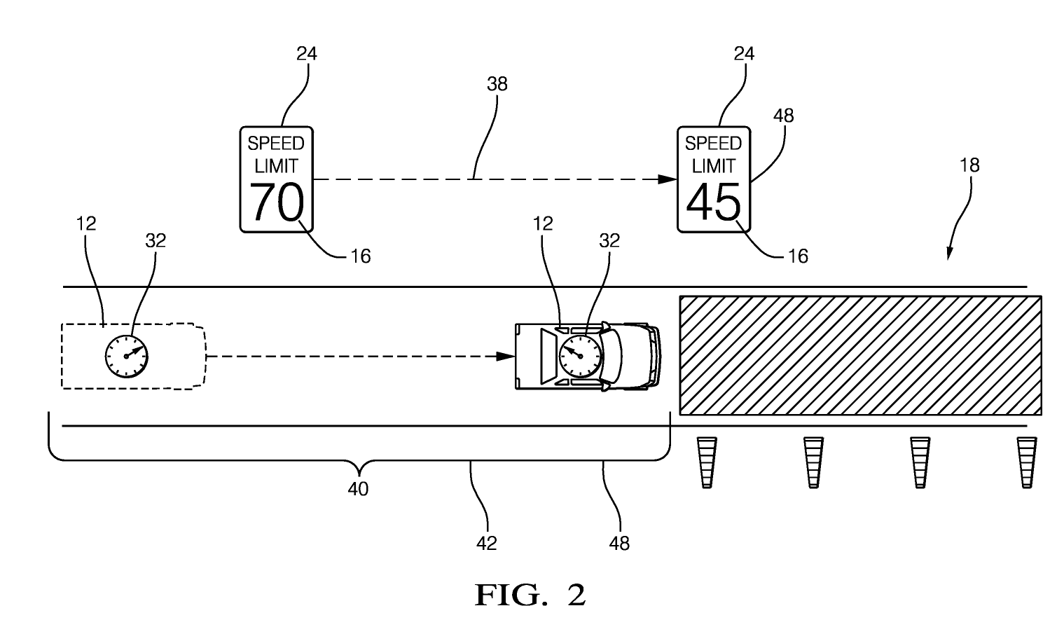

FIG. 2 illustrates a traffic scenario where the host-vehicle 12 is entering a construction-zone (not specifically shown) where the speed-limit 16 of the roadway 18 is reduced. The controller 28 determines a change 38 of the speed-limit 16 of the roadway 18 based on the speed-limit-detection-means 14 (i.e. based on the camera 20, the digital-map 26, or a combination thereof). The controller 28 also determines that a speed-change 40 has occurred based on the speed-sensor 30 when a variation 42 in the speed 32 of the host-vehicle 12 is greater than a variation-threshold 44 (FIG. 1).

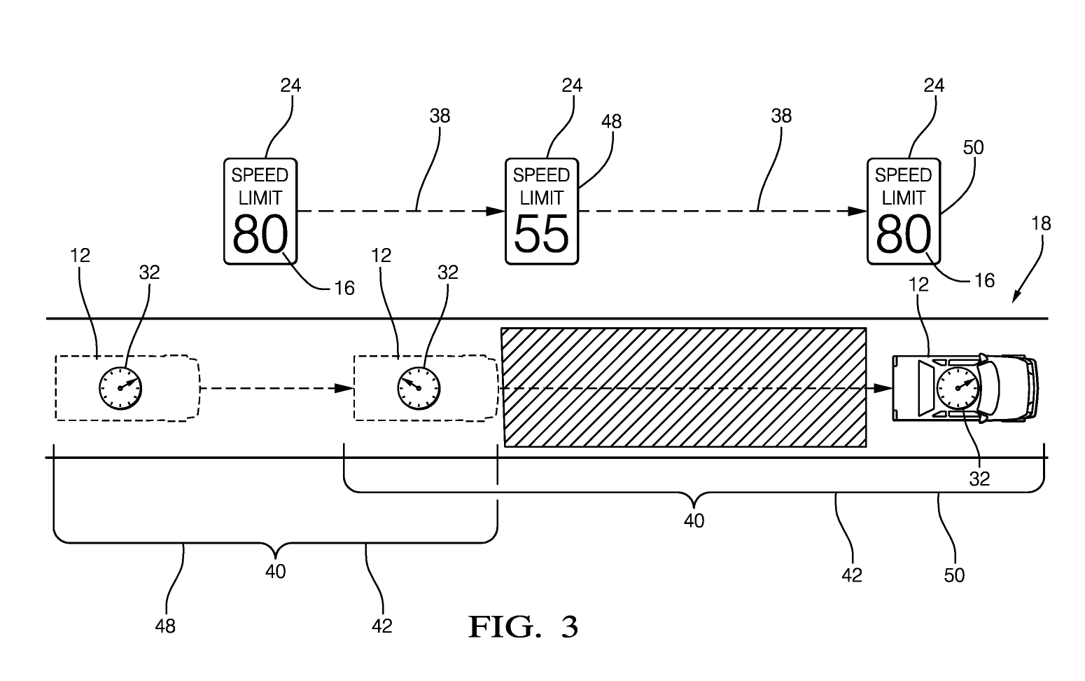

The controller 28 does not increment a count 46 of occurrences of the speed-change 40 when the speed-change 40 correlates (i.e. agrees, matches, trends, equates, etc.) with the change 38 of the speed-limit 16. That is, when the speed-change 40 of the host-vehicle 12 is detected to be trending in the same relative direction as the newly detected speed-limit 16, the controller 28 does not increment the count 46 of the occurrence of the speed-change 40. More specifically, the controller 28 may further determine when the change 38 of the speed-limit 16 indicates a reduction 48 in the speed-limit 16 and does not increment the count 46 of the speed-change 40 when the speed-change 40 indicates the reduction 48 in the speed 32 of the host-vehicle 12, and the reduction 48 in the speed-limit 16 is detected by the controller 28. Conversely, the controller 28 may further determine the change 38 of the speed-limit 16 indicates an increase 50 in the speed-limit 16 and does not increment the count 46 of the speed-change 40 when the speed-change 40 indicates an increase 50 in the speed 32 of the host-vehicle 12, and the increase 50 in the speed-limit 16 is detected by the controller 28 (see FIG. 3).

Returning to FIG. 1, the controller 28 activates the alert-device 34 when the count 46 of occurrences of the speed-change 40 exceeds a change-threshold 52 indicative of driver-fatigue. The change-threshold 52 may be user defined and is preferably be less than three occurrences of the speed-change 40 within a predefined time period. The controller 28 may preferably activate the alert-device 34 when the count 46 of the occurrences of the speed-change 40 exceeds the change-threshold 52 within a time period of less than thirty minutes, and when the variation-threshold 44 is less than twenty-five kilometers per hour (25 kph), and more preferably when the variation-threshold 44 is less than 10 kph.

FIG. 3 illustrates another traffic scenario where the host-vehicle 12 is entering another speed-zone where the speed-limit 16 is initially reduced for a distance along the roadway 18, followed by a return to the previous speed-limit 16. The controller 28 does not increment the count 46 of occurrences of the speed-change 40 when the speed-change 40 correlates (i.e. agrees, matches, trends, equates, etc.) with the change 38 of the speed-limit 16, as illustrated in FIG. 3.

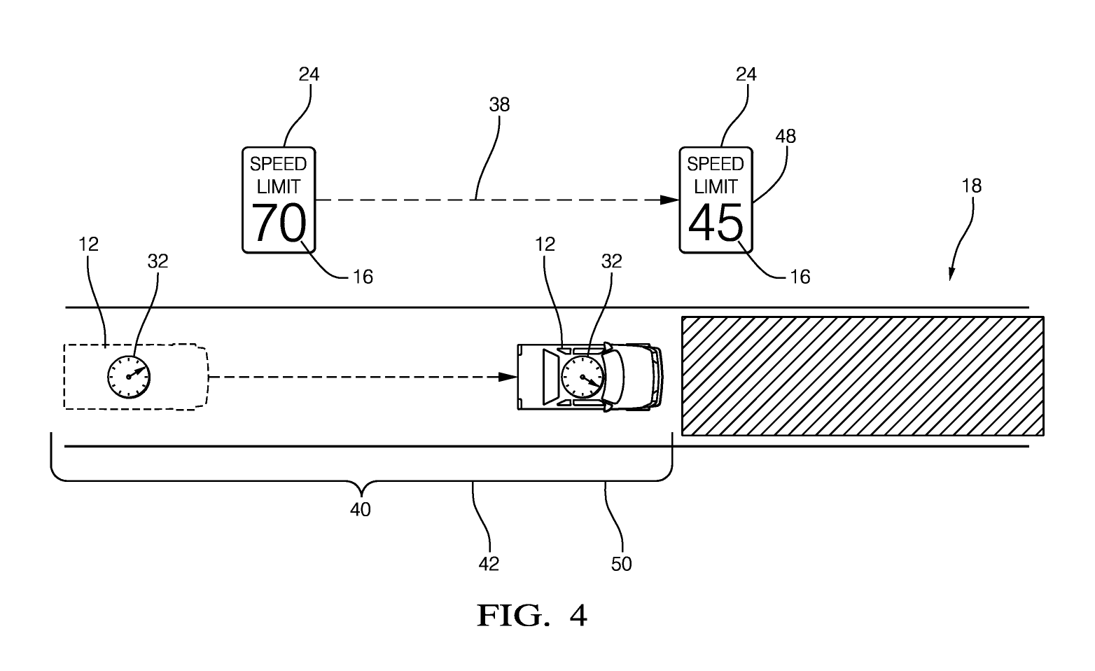

FIG. 4 illustrates yet another traffic scenario where the host-vehicle 12 is entering yet another speed-zone where the speed-limit 16 is reduced. In contrast to FIGS. 2-3, the controller 28 does increment the count 46 of occurrences of the speed-change 40, as the speed-change 40 of the host-vehicle 12 does not correlate with the change 38 of the speed-limit 16. That is, the host-vehicle 12 is increasing in speed 32 when the speed-limit 16 is detected by the controller 28 to be the reduction 48 in the speed-limit 16.

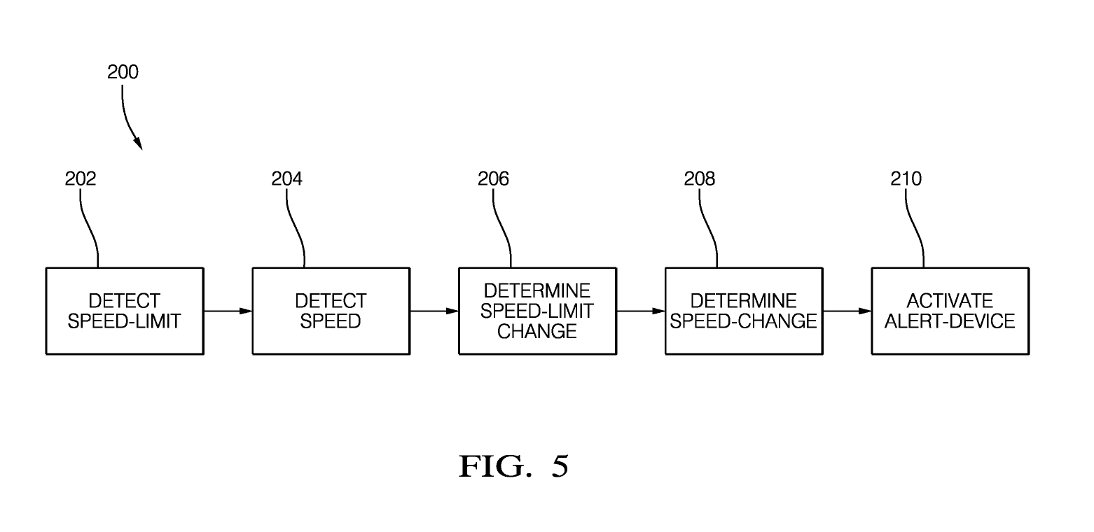

FIG. 5 illustrates a non-limiting example of another embodiment of a method 200 of operating a driver-fatigue warning system 10, hereafter referred to as the system 10, suitable for use on an automated vehicle 12, hereafter referred to as a host-vehicle 12.

Step 202, DETECT SPEED-LIMIT, may include the step of detecting, with a speed-limit-detection-means 14, a speed-limit 16 of a roadway 18 traveled by the host-vehicle 12. The speed-limit-detection-means 14 may be a camera 20 that renders an image 22 of a road-sign 24 proximate to the roadway 18. Examples of the camera 20 suitable for use on the host-vehicle 12 are commercially available as will be recognized by those in the art, one such being the APTINA MT9V023 from Micron Technology, Inc. of Boise, Id., USA. The camera 20 may be mounted on the front of the host-vehicle 12, or mounted in the interior of the host-vehicle 12 at a location suitable for the camera 20 to view the area around the host-vehicle 12 through the windshield of the host-vehicle 12. The camera 20 is preferably a video-type camera 20 or camera 20 that can capture images 22 of the roadway 18 and surrounding area at a sufficient frame-rate, of ten frames per second, for example.

The speed-limit-detection-means 14 may be a digital-map 26 that indicates the speed-limit 16 of the roadway 18. The digital-map 26 may be located on-board the host-vehicle 12 and may be integrated into a controller 28. The digital-map 26 may be stored ‘in the cloud’ and accessed via a transceiver (e.g. Wi-Fi, cellular, satellite—not shown). The digital-map 26 and transceiver may also be part of a location-device (e.g. GPS—not shown).

Step 204, DETECT SPEED, may include the step of detecting, with a speed-sensor 30, a speed 32 of the host-vehicle 12. The speed-sensor 30 may include a wheel-speed-sensor (not shown) typically found on automotive applications. Other sensors capable of determining the speed 32 of the host-vehicle 12 may include, but are not limited to, a global-positioning-system (GPS) receiver (not shown), and a RADAR transceiver (not shown), and other devices as will be recognized by those skilled in the art.

Step 206, DETERMINE SPEED-LIMIT CHANGE, may include the step of determining, with a controller 28 in communication with the speed-limit-detection-means 14, the speed-sensor 30, and an alert-device 34, a change 38 of the speed-limit 16 of the roadway 18 based on the speed-limit-detection-means 14. The controller 28 may include a processor (not shown) such as a microprocessor or other control circuitry such as analog and/or digital control circuitry including an application specific integrated circuit (ASIC) for processing data as should be evident to those in the art. The controller 28 may include a memory (not specifically shown), including non-volatile memory, such as electrically erasable programmable read-only memory (EEPROM) for storing one or more routines, thresholds, and captured data. The one or more routines may be executed by the processor to perform steps for determining if a detected instance of driver-fatigue exists based on signals received by the controller 28 from the speed-limit-detection-means 14 and the speed-sensor 30, as described herein.

The controller 28 may be configured to receive the image 22 from the camera 20 and detect characters (not specifically shown) on the road-sign 24 in order to determine the speed-limit 16. The controller 28 may use known optical-character-recognition (OCR) methods to match the characters in the image 22 captured by the camera 20 with the characters in a database (not specifically shown). One skilled in the art of OCR will recognize that methods such as optical-word-recognition (OWR), intelligent-character-recognition (ICR), and intelligent-word-recognition (IWR) are all considered OCR methods and may be applied by the controller 28 to determine the speed-limit 16. The OCR methods may include pre-processing of the image 22 to improve the success rate of recognition of the characters, matrix-matching, feature extraction, and application-specific optimizations, and will be recognized by those skilled in the art of OCR.

The controller 28 may also include an internet-transceiver (not shown) that updates the digital-map 26 with speed-limit 16 information. The internet-transceiver may be any internet-transceiver suitable for automotive applications and may include Wi-Fi, cellular, and satellite devices (not shown). Step 208, DETERMINE SPEED-CHANGE, may include the step of determining, with the controller 28, that a speed-change 40 has occurred based on the speed-sensor 30 when a variation 42 in the speed 32 is greater than a variation-threshold 44. FIG. 2 illustrates a traffic scenario where the host-vehicle 12 is entering a construction-zone (not specifically shown) where the speed-limit 16 of the roadway 18 is reduced. The controller 28 determines the change 38 of the speed-limit 16 of the roadway 18 based on the speed-limit-detection-means 14 (i.e. based on the camera 20, the digital-map 26, or a combination thereof). The controller 28 also determines that a speed-change 40 has occurred based on the speed-sensor 30 when a variation 42 in the speed 32 of the host-vehicle 12 is greater than a variation-threshold 44 (FIG. 1).

The controller 28 does not increment a count 46 of occurrences of the speed-change 40 when the speed-change 40 correlates (i.e. agrees, matches, trends, equates, etc.) with the change 38 of the speed-limit 16. That is, when the speed-change 40 of the host-vehicle 12 is detected to be trending in the same relative direction as the newly detected speed-limit 16, the controller 28 does not increment the count 46 of the occurrence of the speed-change 40. More specifically, the controller 28 may further determine when the change 38 of the speed-limit 16 indicates a reduction 48 in the speed-limit 16 and does not increment the count 46 of the speed-change 40 when the speed-change 40 indicates the reduction 48 in the speed 32 of the host-vehicle 12, and the reduction 48 in the speed-limit 16 is detected by the controller 28. Conversely, the controller 28 may further determine the change 38 of the speed-limit 16 indicates an increase 50 in the speed-limit 16 and does not increment the count 46 of the speed-change 40 when the speed-change 40 indicates the increase 50 in the speed 32 of the host-vehicle 12, and the increase 50 in the speed-limit 16 is detected by the controller 28 (see FIG. 3).

Step 210, ACTIVATE ALERT-DEVICE, may include the step of activating, with the controller 28, the alert-device 34 when the count 46 of occurrences of the speed-change 40 exceeds a change-threshold 52 indicative of driver-fatigue. The alert-device 34 may be an indicator viewable by the operator 36 that is illuminated to indicate an instance of driver-fatigue, and/or an audible alarm, and/or a vibratory alarm that is activated to indicate the same.

Returning to FIG. 1, the controller 28 activates the alert-device 34 when the count 46 of occurrences of the speed-change 40 exceeds a change-threshold 52 indicative of driver-fatigue. The change-threshold 52 may be user defined and is preferably be less than three occurrences of the speed-change 40 within a predefined time period. The controller 28 may preferably activate the alert-device 34 when the count 46 of the occurrences of the speed-change 40 exceeds the change-threshold 52 within a time period of less than thirty minutes, and when the variation-threshold 44 is less than twenty-five kilometers per hour (25 kph), and more preferably when the variation-threshold 44 is less than 10 kph.

FIG. 3 illustrates another traffic scenario where the host-vehicle 12 is entering another speed-zone where the speed-limit 16 is initially reduced for a distance along the roadway 18, followed by a return to the previous speed-limit 16. The controller 28 does not increment the count 46 of occurrences of the speed-change 40 when the speed-change 40 correlates with the change 38 of the speed-limit 16, as illustrated in FIG. 3.

FIG. 4 illustrates yet another traffic scenario where the host-vehicle 12 is entering yet another speed-zone where the speed-limit 16 is reduced. In contrast to FIGS. 2-3, the controller 28 does increment the count 46 of occurrences of the speed-change 40, as the speed-change 40 of the host-vehicle 12 does not correlate with the change 38 of the speed-limit 16. That is, the host-vehicle 12 is increasing in speed 32 when the speed-limit 16 is detected by the controller 28 to be the reduction 48 in the speed-limit 16.

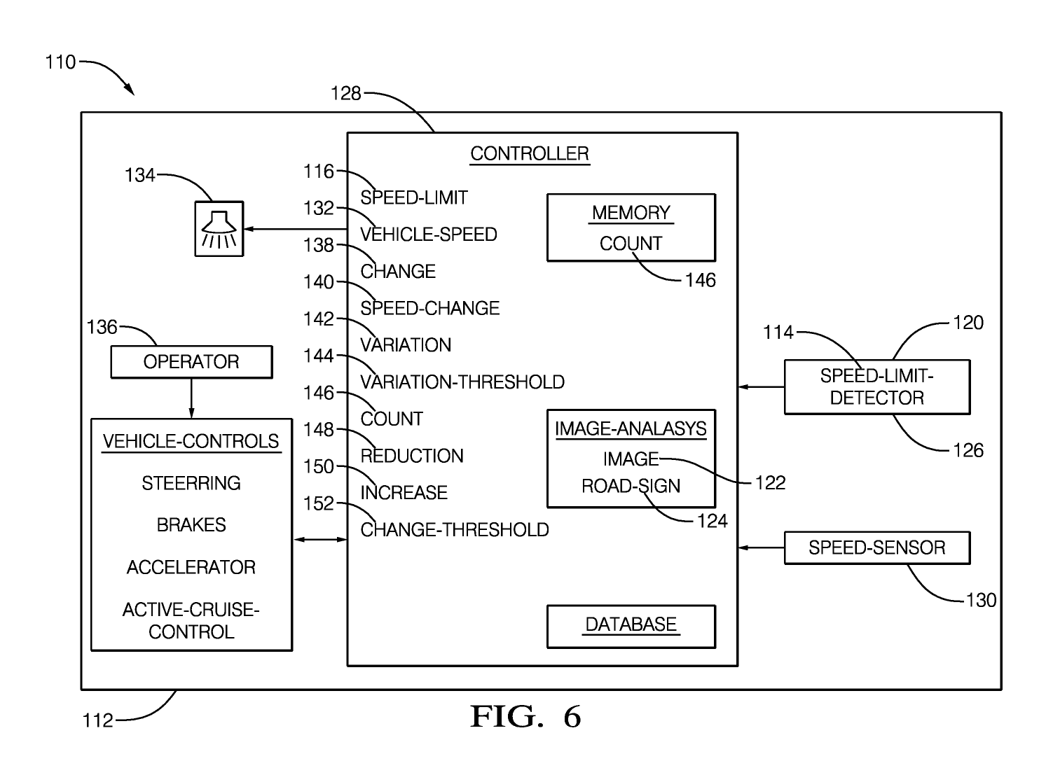

FIG. 6 illustrates a non-limiting example of yet another embodiment of an automated vehicular warning system 110, hereafter referred to as the system 110, suitable for use on an automated vehicle 112, hereafter referred to a host-vehicle 112. The system 110 includes a speed-limit-detector 114 that detects a speed-limit 116 of a roadway 118 traveled by the host-vehicle 112. The speed-limit-detector 114 may be a camera 120 that renders an image 122 of a road-sign 124 proximate to the roadway 118. Examples of the camera 120 suitable for use on the host-vehicle 112 are commercially available as will be recognized by those in the art, one such being the APTINA MT9V023 from Micron Technology, Inc. of Boise, Id., USA. The camera 120 may be mounted on the front of the host-vehicle 112, or mounted in the interior of the host-vehicle 112 at a location suitable for the camera 120 to view the area around the host-vehicle 112 through the windshield of the host-vehicle 112. The camera 120 is preferably a video-type camera 120 or camera 120 that can capture images 122 of the roadway 118 and surrounding area at a sufficient frame-rate, of ten frames per second, for example.

The speed-limit-detector 114 may be a digital-map 126 that indicates the speed-limit 116 of the roadway 118. The digital-map 126 may be located on-board the host-vehicle 112 and may be integrated into a controller 128. The digital-map 126 may be stored ‘in the cloud’ and accessed via a transceiver (e.g. Wi-Fi, cellular, satellite—not shown). The digital-map 126 and transceiver may also be part of a location-device (e.g. GPS—not shown).

The system 110 also includes a speed-sensor 130 that detects a vehicle-speed 132 of the host-vehicle 112. The speed-sensor 130 may include a wheel-speed-sensor (not shown) typically found on automotive applications. Other sensors capable of determining the vehicle-speed 132 of the host-vehicle 112 may include, but are not limited to, a global-positioning-system (GPS) receiver (not shown), and a RADAR transceiver (not shown), and other devices as will be recognized by those skilled in the art.

The system 110 also includes an alert-device 134 operable to alert an operator 136 of the host-vehicle 112 of driver-fatigue. The alert-device 134 may be an indicator viewable by the operator 136 that is illuminated to indicate an instance of driver-fatigue, and/or an audible alarm, and/or a vibratory alarm that is activated to indicate the same.

The system 110 also includes the controller 128 in communication with the speed-limit-detector 114, the speed-sensor 130, and the alert-device 134. The controller 128 may include a processor (not shown) such as a microprocessor or other control circuitry such as analog and/or digital control circuitry including an application specific integrated circuit (ASIC) for processing data as should be evident to those in the art. The controller 128 may include a memory (not specifically shown), including non-volatile memory, such as electrically erasable programmable read-only memory (EEPROM) for storing one or more routines, thresholds, and captured data. The one or more routines may be executed by the processor to perform steps for determining if a detected instance of driver-fatigue exists based on signals received by the controller 128 from the speed-limit-detector 114 and the speed-sensor 130, as described herein.

The controller 128 may be configured to receive the image 122 from the camera 120 and detect characters (not specifically shown) on the road-sign 124 in order to determine the speed-limit 116. The controller 128 may use known optical-character-recognition (OCR) methods to match the characters in the image 122 captured by the camera 120 with the characters in a database (not specifically shown). One skilled in the art of OCR will recognize that methods such as optical-word-recognition (OWR), intelligent-character-recognition (ICR), and intelligent-word-recognition (IWR) are all considered OCR methods and may be applied by the controller 128 to determine the speed-limit 116. The OCR methods may include pre-processing of the image 122 to improve the success rate of recognition of the characters, matrix-matching, feature extraction, and application-specific optimizations, and will be recognized by those skilled in the art of OCR.

The controller 128 may also include an internet-transceiver (not shown) that updates the digital-map 126 with speed-limit 116 information. The internet-transceiver may be any internet-transceiver suitable for automotive applications and may include Wi-Fi, cellular, and satellite devices (not shown).

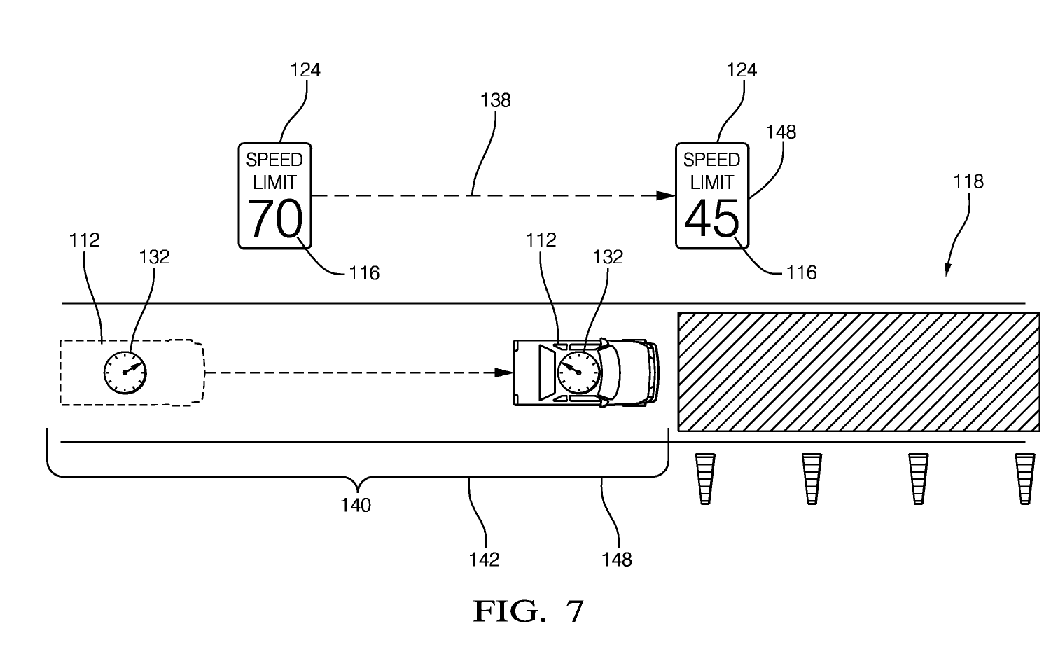

FIG. 7 illustrates a traffic scenario where the host-vehicle 112 is entering a construction-zone (not specifically shown) where the speed-limit 116 of the roadway 118 is reduced. The controller 128 determines a change 138 of the speed-limit 116 of the roadway 118 based on the speed-limit-detector 114 (i.e. based on the camera 120, the digital-map 126, or a combination thereof). The controller 128 also determines that a speed-change 140 has occurred based on the speed-sensor 130 when a variation 142 in the vehicle-speed 132 of the host-vehicle 112 is greater than a variation-threshold 144 (FIG. 6).

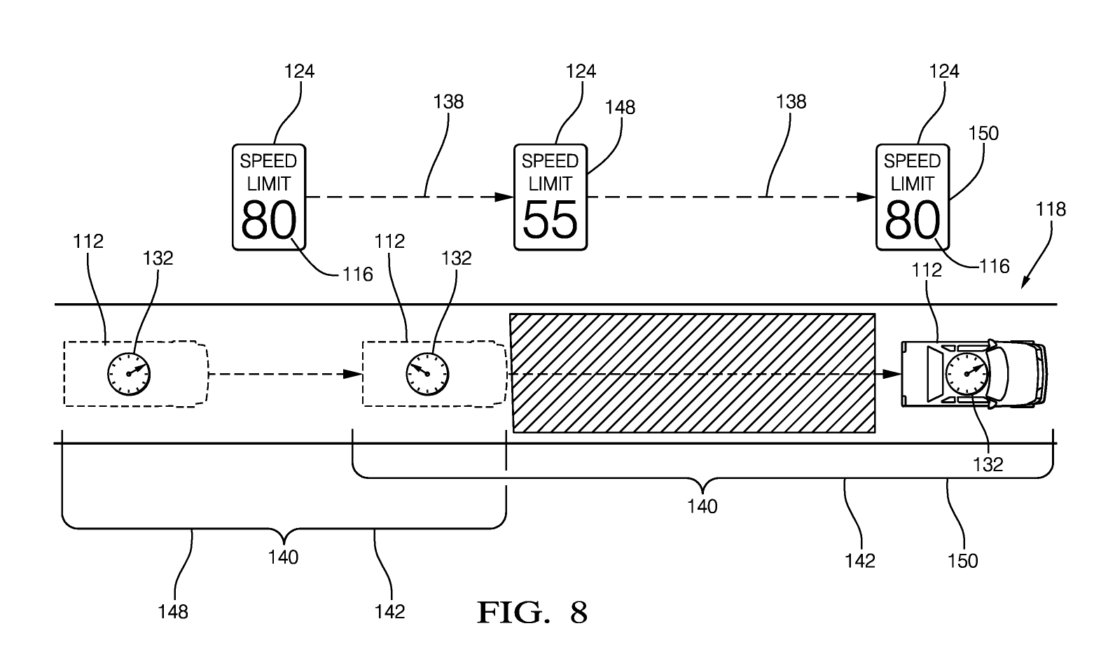

The controller 128 does not increment a count 146 of occurrences of the speed-change 140 when the speed-change 140 agrees (i.e. correlates, matches, trends, equates, etc.) with the change 138 of the speed-limit 116. That is, when the speed-change 140 of the host-vehicle 112 is detected to be trending in the same relative direction as the newly detected speed-limit 116, the controller 128 does not increment the count 146 of the occurrence of the speed-change 140. More specifically, the controller 128 may further determine when the change 138 of the speed-limit 116 indicates a reduction 148 in the speed-limit 116 and does not increment the count 146 of the speed-change 140 when the speed-change 140 indicates the reduction 148 in the vehicle-speed 132 of the host-vehicle 112, and the reduction 148 in the speed-limit 116 is detected by the controller 128. Conversely, the controller 128 may further determine the change 138 of the speed-limit 116 indicates an increase 150 in the speed-limit 16 and does not increment the count 146 of the speed-change 140 when the speed-change 140 indicates the increase 150 in the vehicle-speed 132 of the host-vehicle 112, and the increase 150 in the speed-limit 116 is detected by the controller 128 (see FIG. 8).

Returning to FIG. 6, the controller 128 activates the alert-device 134 when the count 146 of occurrences of the speed-change 140 exceeds a change-threshold 152 indicative of driver-fatigue. The change-threshold 152 may be user defined and is preferably be less than three occurrences of the speed-change 140 within a predefined time period. The controller 128 may preferably activate the alert-device 134 when the count 146 of the occurrences of the speed-change 140 exceeds the change-threshold 152 within a time period of less than thirty minutes, and when the variation-threshold 144 is less than twenty-five kilometers per hour (25 kph), and more preferably when the variation-threshold 144 is less than 10 kph.

FIG. 8 illustrates another traffic scenario where the host-vehicle 112 is entering another speed-zone where the speed-limit 116 is initially reduced for a distance along the roadway 118, followed by a return to the previous speed-limit 116. The controller 128 does not increment the count 146 of occurrences of the speed-change 140 when the speed-change 140 agrees with the change 138 of the speed-limit 116, as illustrated in FIG. 8.

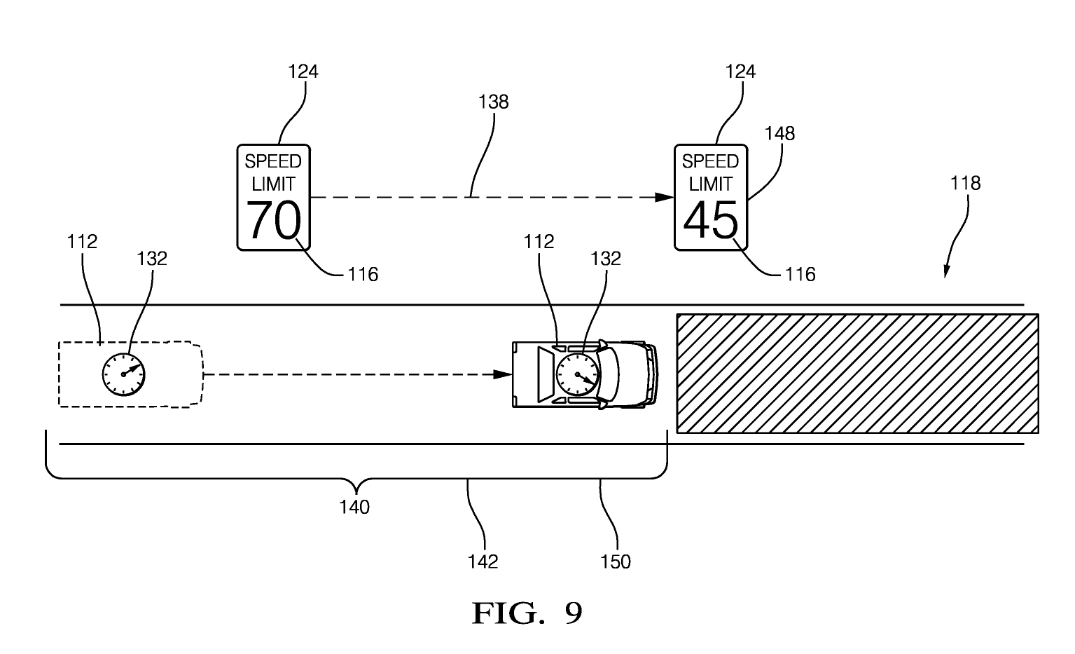

FIG. 9 illustrates yet another traffic scenario where the host-vehicle 112 is entering yet another speed-zone where the speed-limit 116 is reduced. In contrast to FIGS. 7-8, the controller 128 does increment the count 146 of occurrences of the speed-change 140, as the speed-change 140 of the host-vehicle 112 does not correlate with the change 138 of the speed-limit 116. That is, the host-vehicle 112 is increasing in vehicle-speed 132 when the speed-limit 116 is detected by the controller 128 to be the reduction 148 in the speed-limit 16.

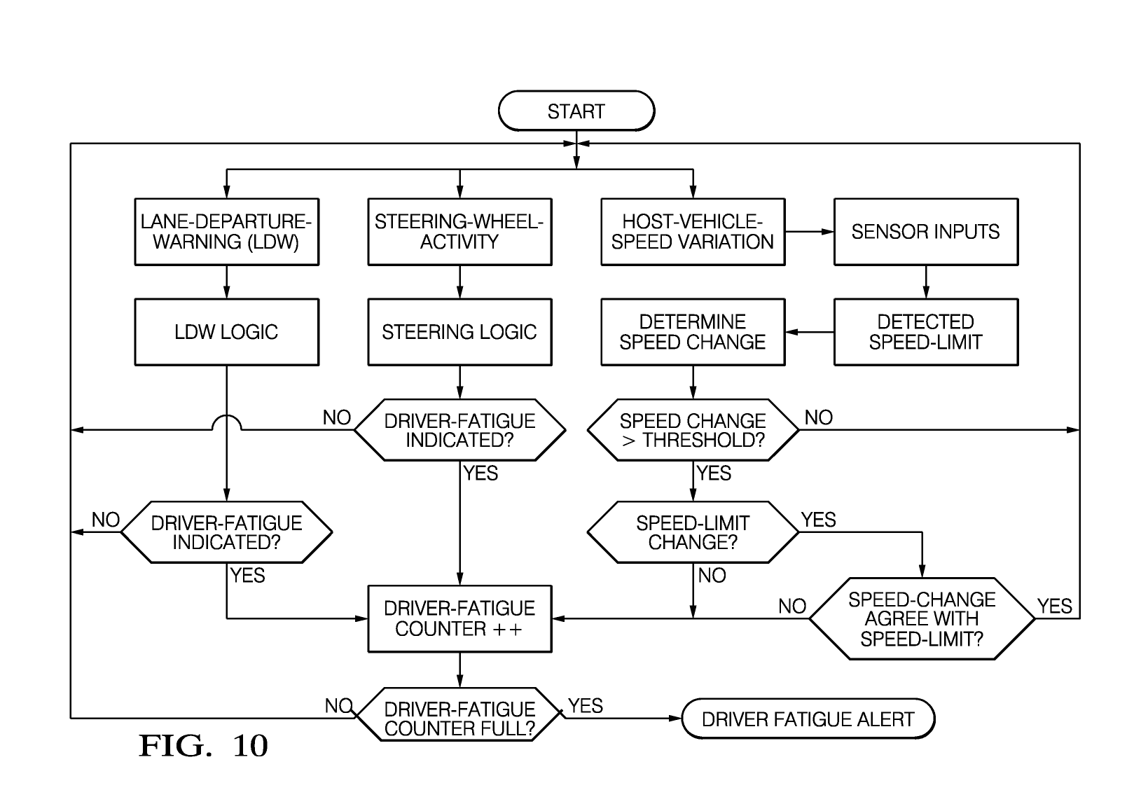

FIG. 10 illustrates a non-limiting example of the driver-fatigue algorithm that may be stored in the memory of the controller 28. The driver-fatigue algorithm may include logic that includes making decisions based on sensor input, lane-departure-warnings, steering-wheel-activity, and host-vehicle-speed.

Accordingly, a driver-fatigue warning system 10, a controller 28 for the driver-fatigue warning system 10 and a method 200 of operating the driver-fatigue warning system 10 is provided. The system 10 reduces the rates of the false driver-fatigue warning by determining when to count 46 the speed-change 40, which may help to reduce occurrences of operators 36 intentionally deactivating the driver-fatigue warning system 10. By not counting 46 the occurrences of the speed-change 40 under the conditions described above, the system 10 does not penalize the operator 36 of the host-vehicle 12 when the operator 36 makes an intentional speed-change 40. The operator 36 may make the intentional speed-change 40 to in observance of the traffic laws.

While this invention has been described in terms of the preferred embodiments thereof, it is not intended to be so limited, but rather only to the extent set forth in the claims that follow.

1. A driver-fatigue warning system suitable for use on an automated vehicle, said system comprising:
a speed-limit-detection-means that detects a speed-limit of a roadway traveled by a host-vehicle;
a speed-sensor that detects a speed of the host-vehicle;
an alert-device operable to alert an operator of the host-vehicle of driver-fatigue; and
a controller in communication with the speed-limit-detection-means, the speed-sensor, and the alert-device, said controller determines a change of the speed-limit of the roadway based on the speed-limit-detection-means, determines that a speed-change has occurred based on the speed-sensor when a variation in the speed is greater than a variation-threshold, does not increment a count of occurrences of the speed-change when the speed-change correlates with the change of the speed-limit, and activates the alert-device when the count of occurrences of the speed-change exceeds a change-threshold indicative of driver-fatigue.

2. The system in accordance with claim 1, wherein the speed-limit-detection-means includes a camera that renders an image of a road-sign proximate to the roadway, and wherein the controller further determines the change of the speed-limit of the roadway based on the image.

3. The system in accordance with claim 1, wherein the speed-limit-detection-means includes a digital-map that indicates the speed-limit of the roadway, and wherein the controller further determines the change of the speed-limit of the roadway based on the digital-map.

4. The system in accordance with claim 1, wherein the controller further determines when the change of the speed-limit indicates a reduction in the speed-limit, wherein the controller does not increment the count of the speed-change when the speed-change indicates the reduction in the speed of the host-vehicle, and the reduction in the speed-limit is detected.

5. The system in accordance with claim 1, wherein the controller further determines the change of the speed-limit indicates an increase in the speed-limit, wherein the controller does not increment the count of the speed-change when the speed-change indicates an increase in the speed of the host-vehicle, and an increase in the speed-limit is detected.

6. The system in accordance with claim 1, wherein the controller activates the alert-device when the count of the occurrences of the speed-change exceeds a change-threshold within a time period of less than thirty minutes.

7. The system in accordance with claim 6, wherein the variation-threshold is less than twenty-five kilometers per hour.

8. The system in accordance with claim 7, wherein the variation-threshold is less than ten kilometers per hour.

9. A method of operating a driver-fatigue warning system suitable for use on an automated vehicle, said method comprising the steps of:
detecting, with a speed-limit-detection-means, a speed-limit of a roadway traveled by a host-vehicle;
detecting, with a speed-sensor, a speed of the host-vehicle;
alerting, with an alert-device, an operator of the host-vehicle of driver-fatigue; and
determining, with a controller in communication with the speed-limit-detection-means, the speed-sensor, and the alert-device, a change of the speed-limit of the roadway based on the speed-limit-detection-means, determining that a speed-change has occurred based on the speed-sensor when a variation in the speed is greater than a variation-threshold, not counting occurrences of the speed-change when the speed-change correlates with the change of the speed-limit, and activating the alert-device when a count of occurrences of the speed-change exceeds a change-threshold indicative of driver-fatigue.

10. The method in accordance with claim 9, wherein the controller further determines when the change of the speed-limit indicates a reduction in the speed-limit, and the controller does not count the speed-change when the speed-change indicates the reduction in the speed of the host-vehicle and the reduction in the speed-limit is detected.

11. The method in accordance with claim 9, wherein the controller further determines when the change of the speed-limit indicates an increase in the speed-limit, and the controller does not count the speed-change when the speed-change indicates an increase in the speed of the host-vehicle and an increase in the speed-limit is detected.

12. The method in accordance with claim 9, wherein the controller activates the alert-device when the count of occurrences of the speed-change exceeds a change-threshold within a time period of less than thirty minutes.

13. The method in accordance with claim 12, wherein the variation-threshold is less than twenty-five kilometers per hour.

14. The method in accordance with claim 13, wherein the variation-threshold is less than ten kilometers per hour.

15. An automated vehicular warning system comprising:
a speed-limit-detector;
a speed-sensor;
an alert-device; and
a controller in communication with the speed-limit detector, the speed-sensor, and the alert-device, said controller determines a change of a speed-limit of a roadway, determines a change of a vehicle-speed, does not count the change of the vehicle-speed when the vehicle-speed agrees with the change of the speed-limit, and activates the alert-device when the count of the change of vehicle-speed exceeds a change-threshold indicative of driver-fatigue.
